(19) United States
(12) Patent Application Publication
(10) Pub. No.: US 2013/0196189 A1
(43) Pub. Date: Aug. 1, 2013

(54) NONAQUEOUS ELECTROLYTE SECONDARY BATTERY, METHOD FOR MANUFACTURING NONAQUEOUS ELECTROLYTE SECONDARY BATTERY, AND VEHICLE COMPRISING NONAQUEOUS ELECTROLYTE SECONDARY BATTERY

(71) Applicants: SANYO Electric Co., Ltd., Osaka (JP); TOYOTA JIDOSHA KABUSHIKI KAISHA, Toyota-shi (JP)

(72) Inventors: Keisuke Minami, Kanzaki-gun (JP); Masahiro Iyori, Kasai-shi (JP); Yoshinori Yokoyama, Kasai-shi (JP); Toyoki Fujihara, Kanzaki-gun (JP); Yasuhiro Yamauchi, Kasai-shi (JP); Toshiyuki Nohma, Kobe-shi (JP); Hironori Harada, Nukata-gun (JP); Toshihiro Takada, Nagoya-shi (JP); Ryuta Morishima, Toyota-shi (JP)

(73) Assignees: TOYOTA JIDOSHA KABUSHIKI KAISHA, Toyota-shi (JP); SANYO ELECTRIC CO., LTD., Osaka (JP)

(21) Appl. No.: 13/750,443

(22) Filed: Jan. 25, 2013

(30) Foreign Application Priority Data
Jan. 27, 2012 (JP) 2012-015948

(51) Int. Cl. H01M 10/42; H01M 10/04

(52) U.S. Cl. CPC H01M 10/4235; H01M 10/04
USPC 429/57; 429/61; 29/623.1

(57) ABSTRACT

A nonaqueous electrolyte secondary battery includes a current interruption mechanism in at least one of a conductive pathway from the positive electrode sheet to the outside of the outer body and a conductive pathway from the negative electrode sheet to the outside of the outer body. The current interruption mechanism interrupts electric current when the pressure in the outer body exceeds a predetermined value. The nonaqueous electrolyte contains an overcharge inhibitor. The overcharge inhibitor is contained in an amount of 3.0% or more and 4.5% or less with respect to the spatial volume in the outer body in terms of volume ratio. The nonaqueous electrolyte secondary battery has excellent output characteristics in a low temperature condition and can sufficiently ensure reliability even when the battery is overcharged through two-step charging in a low temperature condition.

### TECHNICAL FIELD

The present invention relates to a nonaqueous electrolyte secondary battery including a current interruption mechanism that interrupts electric current when the pressure in a battery outer body exceeds a predetermined value, a method for manufacturing the nonaqueous electrolyte secondary battery, and a vehicle comprising the nonaqueous electrolyte secondary battery.

### BACKGROUND ART

In recent years, nonaqueous electrolyte secondary batteries typified by lithium ion secondary batteries have been widely used as power supplies for driving portable electronic equipment such as cell phones, portable personal computers, and portable music players. In addition, as exhaust controls on carbon dioxide gas and other substances have stricter against a backdrop of increasing actions to safeguard the environment, the development of electric vehicles (EVs), plug-in hybrid electric vehicles (PHEVs), hybrid electric vehicles (HEVs), and similar vehicles using a lithium ion secondary battery or similar battery has become accelerated. Large storage battery systems using a lithium ion secondary battery, for example, have been also actively developed.

In this kind of lithium ion secondary batteries, a lithium transition-metal composite oxide such as LiCoO₂, LiNiO₂, and LiMn₂O₄ is used as a positive electrode active material; a carbon material, a silicon material, or other material capable of absorbing and desorbing lithium ions is used as a negative electrode active material; and an electrolyte dissolving a lithium salt as a solute in an organic solvent is used.

A lithium ion secondary battery being overcharged can create problems such as where a positive electrode excessively releases lithium and the lithium is excessively inserted into a negative electrode, resulting in thermally destabilizing both the positive and negative electrodes.

To solve such a problem, for example, a lithium ion secondary battery has been developed in which at least one of the following substances is added to an electrolyte as an overcharge inhibitor in order to suppress the temperature increase at the time of overcharging (see JP-A-2004-134261): biphenyl, cyclohexylbenzene, and diphenyl ether.

A lithium ion secondary battery has also been developed in which an organic solvent of an electrolyte contains an alkylbenzene derivative or a cyclohexylbenzene derivative having a tertiary carbon adjacent to the phenyl group, thereby taking measures against overcharge without adversely affecting battery characteristics such as low-temperature characteristics and storage characteristics (see JP-A-2001-015155).

In the lithium ion secondary battery being overcharged, an additive such as cumene, 1,3-diisopropylbenzene, 1,4-diisopropylbenzene, 1-methylpropylbenzene, 1,3-bis(1-methylpropyl)benzene, 1,4-bis(1-methylpropyl)benzene, cyclohexylbenzene, and cyclopentylbenzene, which are alkylbenzene derivatives, or a cyclohexylbenzene derivative having a tertiary carbon adjacent the phenyl group, starts a decomposition reaction to generate gas. Concurrently with the decomposition, the additive starts a polymerization reaction to generate heat of polymerization. Continuation of the overcharging in this condition increases the amount of gas generated. After some 15 to 19 minutes from the start of overcharging, a current interruption sealing plate works to interrupt the overcharge current. This gradually lowers the battery temperature.

Nonaqueous electrolyte secondary batteries used in EVs, PHEVs, HEVs, and similar, are required to have especially high reliability, and thus preferably employ the technique of adding an overcharge inhibitor to a nonaqueous electrolyte as mentioned above as the measures against overcharge.

During our process of developing nonaqueous electrolyte secondary batteries for vehicles such as EVs, PHEVs, and HEVs, a problem was found that, even if an overcharge inhibitor is added to a nonaqueous electrolyte, a low temperature condition reduces the effect of the overcharge inhibitor thereby extending the time until a current interruption mechanism operates when the battery is in an abnormal condition. Another problem was also found that adding an overcharge inhibitor results in lowering output characteristics in a low temperature condition. A nonaqueous electrolyte secondary battery is supposed to be used in a two-step charging manner that includes a first step charging at a constant rate and a following second step charging in which the battery is further charged at a higher rate. However, in the nonaqueous electrolyte secondary battery comprising a current interruption mechanism, various conditions concerning the activation of the current interruption mechanism are designed on the assumption of overcharging at a constant rate. Thus, the conditions cannot necessarily be applied to the overcharging at the second step (in two-step charging) without any modification. Two-step charging in the present specification is not limited to the above-mentioned charging manner but also includes a charging manner in which a charging rate varies.

### SUMMARY

An advantage of some aspects of the invention is to provide a nonaqueous electrolyte secondary battery that has excellent output characteristics in a low temperature condition and can sufficiently ensure reliability even when the battery is overcharged through two-step charging in a low temperature condition, a method for manufacturing the nonaqueous electrolyte secondary battery, and a vehicle comprising the nonaqueous electrolyte secondary battery.

A nonaqueous electrolyte secondary battery of the invention includes an electrode assembly including a positive electrode sheet; a negative electrode sheet; and a separator interposed between the positive electrode sheet and the negative electrode sheet, and an outer body storing the electrode assembly and a nonaqueous electrolyte. The nonaqueous electrolyte secondary battery further includes a current interruption mechanism in at least one of a conductive pathway from the positive electrode sheet to the outside of the outer body and a conductive pathway from the negative electrode sheet to the outside of the outer body. The current interruption mechanism interrupts electric current when the pressure in the outer body exceeds a predetermined value. In the nonaqueous electrolyte secondary battery, the nonaqueous electrolyte contains an overcharge inhibitor. The overcharge inhibitor is contained in an amount of 3.0% or more and 4.5% or less with respect to the spatial volume in the outer body in terms of volume ratio.

Optimization of the amount of the overcharge inhibitor contained in the nonaqueous electrolyte with respect to the spatial volume in the outer body as above enables the battery to obtain sufficient output characteristics at low temperature and to ensure reliability even when the battery is overcharged through two-step charging in a low temperature condition. In the invention, the overcharge inhibitor generates gas when a battery is overcharged to increase the pressure in an outer body to activate a current interruption mechanism, thereby suppressing further overcharging.

The effects of the overcharge inhibitor lowers in a low temperature condition when a nonaqueous electrolyte contains the overcharge inhibitor in an amount of less than 3% with respect to the spatial volume in the battery outer body in terms of volume ratio. The current interruption mechanism is thus difficult to be immediately activated when a battery is overcharged through two-step charging. This may cause abnormal events such as internal burning and explosion. In contrast, when a nonaqueous electrolyte contains the overcharge inhibitor in an amount of more than 4.5% with respect to the spatial volume in the battery outer body in terms of volume ratio, the output characteristics in a low temperature condition are reduced. Such a nonaqueous electrolyte cannot provide a nonaqueous electrolyte secondary battery requiring high output characteristics, especially, a nonaqueous electrolyte secondary battery suited for a nonaqueous electrolyte secondary battery for vehicles.

In the invention, it is preferable that the overcharge inhibitor be a compound having at least one of a cyclohexyl group and a phenyl group. When a battery including the compound having at least one of a cyclohexyl group and a phenyl group is overcharged, the cyclohexyl group is oxidized on the positive electrode surface into a phenyl group to generate hydrogen gas, and the phenyl group further oxidatively decomposes to generate hydrogen gas. Hence, when a battery including a nonaqueous electrolyte containing the compound having at least one of a cyclohexyl group and a phenyl group is overcharged, the battery internal pressure can increase for a short period of time to immediately activate the current interruption mechanism.

In the invention, it is preferable that the compound having at least one of a cyclohexyl group and a phenyl group be at least one compound selected from cumene, 1,3-diisopropylbenzene, 1,4-diisopropylbenzene, 1-methylpropylbenzene, 1,3-bis(1-methylpropyl)benzene, 1,4-bi s(1-methylpropyl)benzene, t-butylbenzene, t-dibutylbenzene, t-amylbenzene, t-diamylbenzene, cyclohexylbenzene, cyclopentylbenzene, biphenyl, and diphenyl ether. A compound having a cyclohexyl group and a phenyl group is more preferred, and cyclohexylbenzene is particularly preferred.

In the invention, it is preferable that a nonaqueous solvent included in the nonaqueous electrolyte contain at least one solvent selected from the group consisting of ethylene carbonate, ethyl methyl carbonate, and dimethyl carbonate. This enables the nonaqueous electrolyte secondary battery to have excellent battery characteristics and high reliability.

It is preferable that the nonaqueous electrolyte secondary battery of the invention have a gas exhaust valve for exhausting gas in the outer body to the outside of the outer body when the pressure in the outer body exceeds a predetermined value, the current interruption mechanism work at a pressure lower than that for the gas exhaust valve, and the current interruption mechanism work at a pressure of 0.4 MPa or more and 1.0 MPa or less.

A current interruption mechanism having a working pressure of 0.4 MPa or more can reliably prevent the current interruption mechanism from a malfunction even when vibration or impact is applied to a battery. A current interruption mechanism having a working pressure of 1.0 MPa or less can reliably prevent a battery from abnormal events such as internal burning and explosion before the current interruption mechanism works. Hence, the current interruption mechanism preferably works at a pressure of 0.4 MPa or more and 1.0 MPa or less. In addition, the gas exhaust valve provided in the nonaqueous electrolyte secondary battery can further improve the reliability. The current interruption mechanism is required to have a working pressure lower than the working pressure of the gas exhaust valve in order to normally activate the current interruption mechanism.

In the invention, it is preferable that the positive electrode active material contain a lithium transition-metal composite oxide capable of absorbing and desorbing lithium ions. It is also preferable that the negative electrode active material contain a carbon material capable of absorbing and desorbing lithium ions.

Examples of the lithium transition-metal composite oxide capable of absorbing and desorbing lithium ions include lithium transition-metal oxides such as lithium cobalt oxide (LiCoO₂), lithium manganese oxide (LiMn₂O₄), lithium nickel oxide (LiNiO₂), lithium nickel manganese composite oxide (LiNi₁₋ₓMnₓO₂ (0<x<1)), lithium nickel cobalt composite oxide LiNi₁₋ₓCoₓO₂ (0<x<1), and lithium nickel cobalt manganese composite oxide (LiNiₓMn_{y}Co_{z}O₂ (0<x<1, 0<y<1, 0<z<1, x+y+z=1). Composite oxides obtained by adding Al, Ti, Zr, Nb, B, Mg, Mo, or other elements to the lithium transition-metal composite oxide may also be used. Examples of such a composite oxide include lithium transition-metal composite oxides represented by Li₁₊ₐNiₓCo_{y}Mn_{z}M_{b}O₂ (M=at least one element selected from Al, Ti, Zr, Nb, B, Mg, and Mo, 0≦a≦0.2, 0.2≦x0.5, 0.2≦y≦0.5, 0.2≦z≦0.4, 0≦b≦0.02, a+b+x+y+z=1).

Examples of the carbon materials capable of absorbing and desorbing lithium ions include graphite, non-graphitizable carbon, graphitizable carbon, fibrous carbon, coke, and carbon black. Graphite is particularly preferably used.

In the invention, it is preferable that at least one of the positive electrode sheet and the negative electrode sheet have a surface provided with a protective layer including an inorganic oxide and a binder, and that the inorganic oxide be at least one selected from alumina, titania, and zirconia.

This can prevent a short circuit between the positive electrode sheet and the negative electrode sheet even when an electrically conductive foreign substance enters the electrode assembly, thereby providing a nonaqueous electrolyte secondary battery having high reliability.

In the invention, it is preferable that: the outer body be a prismatic outer body; the electrode assembly be a flat electrode assembly; the flat electrode assembly have one end with a plurality of stacked positive electrode substrate exposed portions and have the other end with a plurality of stacked negative electrode substrate exposed portions; the positive electrode substrate exposed portions be disposed to face one sidewall of the prismatic outer body; the negative electrode substrate exposed portions be disposed to face the other sidewall of the prismatic outer body; the positive electrode substrate exposed portions be connected to a positive electrode collector; and the negative electrode substrate exposed portions be connected to a negative electrode collector.

Such a structure in which the plurality of substrate exposed portions are connected to the collector leads to a nonaqueous electrolyte secondary battery having excellent output characteristics.

A method for manufacturing the nonaqueous electrolyte secondary battery of the invention includes: preparing an electrode assembly including a positive electrode sheet, a negative electrode sheet, and a separator interposed between the positive electrode sheet and the negative electrode sheet; storing the electrode assembly and a nonaqueous electrolyte containing an overcharge inhibitor in an outer body, and adjusting the nonaqueous electrolyte to contain the overcharge inhibitor in an amount of 3.0% or more and 4.5% or less with respect to the spatial volume in the outer body in terms of volume ratio; and sealing up the outer body.

The method can provide a nonaqueous electrolyte secondary battery having sufficient output characteristics at low temperature and having high reliability even when the battery is overcharged through two-step charging in a low temperature condition.

By using the nonaqueous electrolyte secondary battery of the invention in a vehicle such as an electric vehicle (EV) and a hybrid electric vehicle (HEV, PHEV), the vehicle obtains high performance and high reliability.

### BRIEF DESCRIPTION OF THE DRAWINGS

The invention will be described with reference to the accompanying drawings, wherein like numbers reference like elements.

FIG. 1 is a perspective view of a prismatic lithium ion secondary battery of examples and comparative examples.

FIG. 2 is an exploded perspective view of a positive electrode conductive pathway of the prismatic lithium ion secondary battery shown in FIG. 1.

FIG. 3 is a sectional view of the positive electrode conductive pathway of the prismatic lithium ion secondary battery shown in FIG. 1.

### DESCRIPTION OF EXEMPLARY EMBODIMENTS

The invention will be described in detail with reference to examples and comparative examples below. However, the examples described below are merely illustrative examples of nonaqueous electrolyte secondary batteries for embodying the technical spirit of the invention and are not intended to limit the invention to the examples, and the invention may be equally applied to various modified cases without departing from the technical spirit described in the claims.

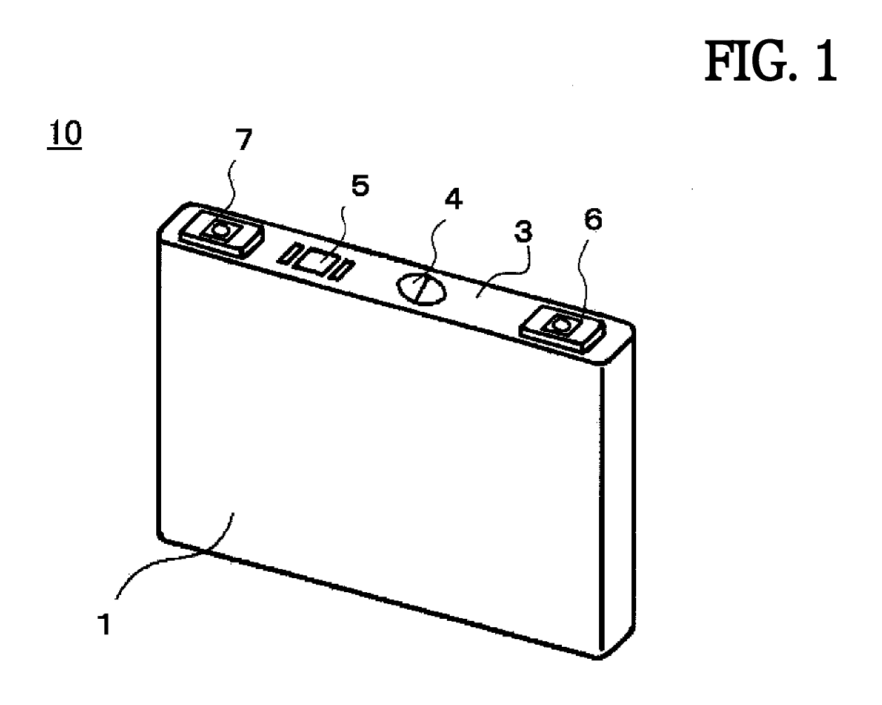

First, the structure of a prismatic lithium ion secondary battery 10 as a nonaqueous electrolyte secondary battery of examples and comparative examples will be described with reference to FIG. 1 to FIG. 3. As shown in FIG. 1, the prismatic lithium ion secondary battery 10 includes a prismatic cylinder-shaped outer can 1 with a bottom. A positive electrode sheet and a negative electrode sheet are stacked while interposing a separator therebetween, and the whole is wound to be formed into a flat electrode assembly 2. The electrode assembly 2 is stored in the outer can 1 laterally with respect to the can axis direction of the outer can 1. A mouth of the outer can 1 is sealed with a sealing plate 3. The sealing plate 3 has a gas exhaust valve 4, an electrolyte pour hole (not shown in the drawings), and a sealing member 5 sealing the electrolyte pour hole. The gas exhaust valve 4 fractures when a gas pressure higher than the working pressure of the current interruption mechanism is applied, thereby exhausting gas to the outside of the battery.

The sealing plate 3 has an outer surface on which an external positive electrode terminal 6 and an external negative electrode terminal 7 are formed. The external positive electrode terminal 6 and the external negative electrode terminal 7 may have shapes modified as appropriate depending on whether the lithium ion secondary battery is used alone or the lithium ion secondary batteries are used by being connected in series or in parallel. A terminal board, an external connecting terminal having a bolt shape, or other elements (not shown in the drawings) may be used by mounting to the external positive electrode terminal 6 and the external negative electrode terminal 7.

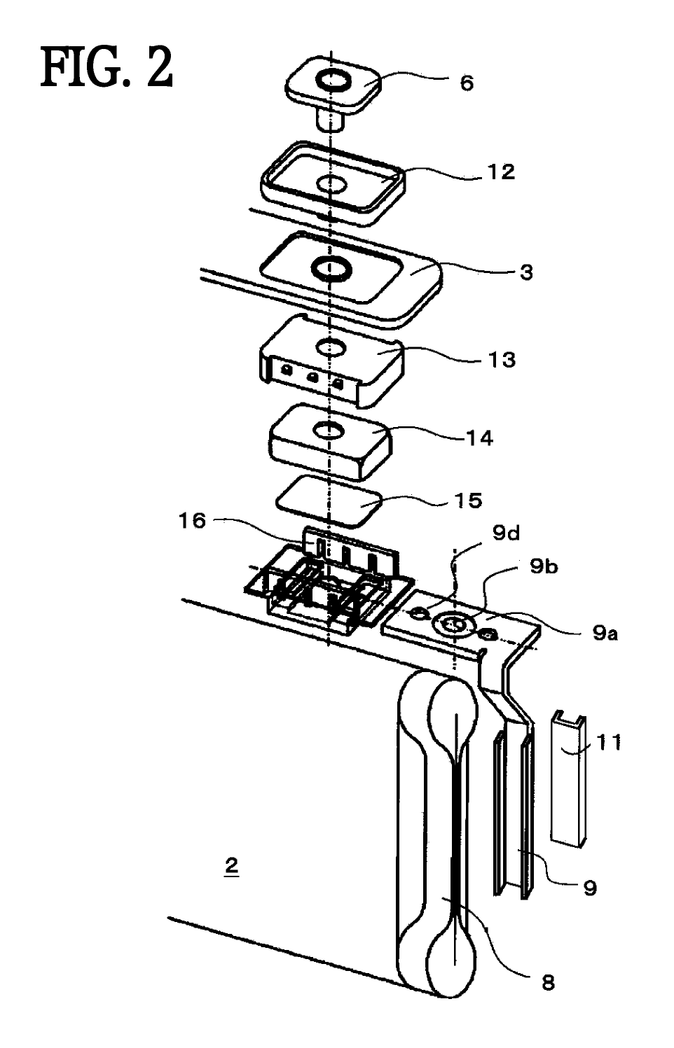

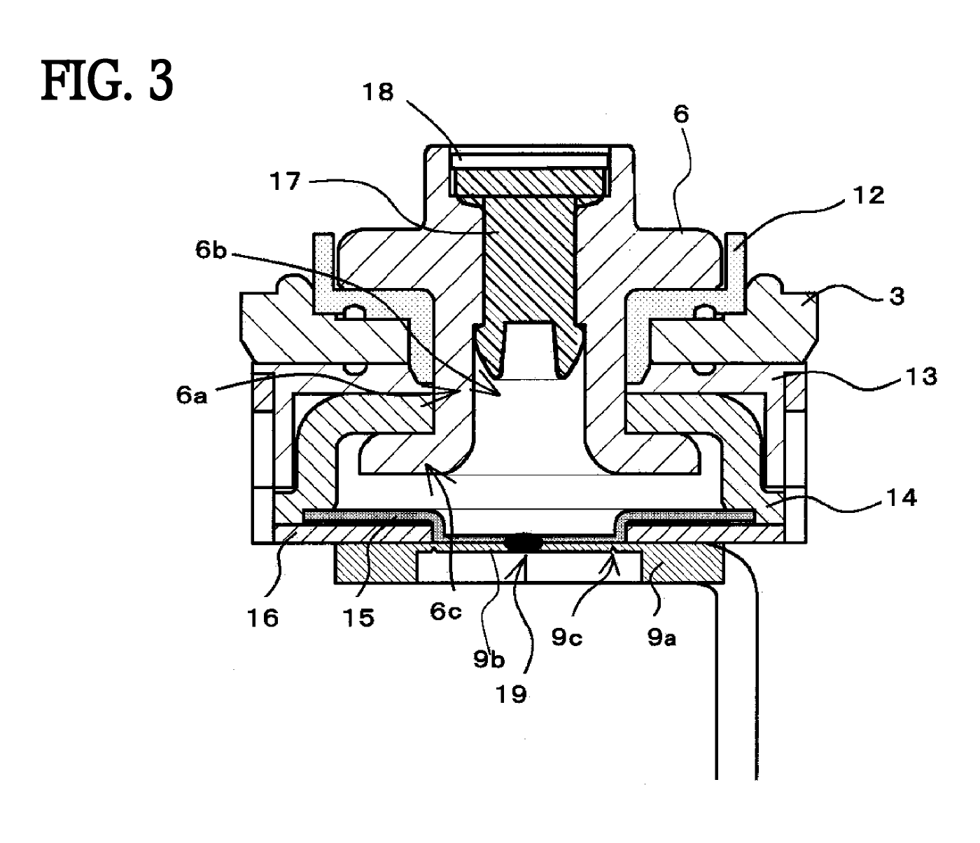

The structure of a current interruption mechanism provided in the prismatic lithium ion secondary battery 10 will next be described with reference to FIG. 2 and FIG. 3. FIG. 2 and FIG. 3 are an exploded perspective view of a positive electrode conductive pathway and a sectional view of the positive electrode conductive pathway, respectively. Both outer surfaces of a positive electrode substrate exposed portion 8 protruding from one end of the electrode assembly 2 are connected to a collector 9 and a collector receiving part 11. The external positive electrode terminal 6 has a cylinder portion 6a in which a through-hole 6b is formed. The cylinder portion 6a of the external positive electrode terminal 6 is inserted into through-holes formed in a gasket 12, the sealing plate 3, an insulating member 13, and a cup-shaped conductive member 14, and a leading end portion 6c of the external positive electrode terminal 6 is crimped to integrally fix the parts.

A peripheral part of the lower end of a cylinder-shaped portion of the conductive member 14 is welded to the periphery of a reversion plate 15. The central part of the reversion plate 15 is welded to a thin-wall portion 9b formed in a tab 9a of the collector 9 by laser-welding and a welded portion 19 is thus formed. An annular groove 9c is formed around the welded portion 19 on the thin-wall portion 9b formed in the tab 9a of the collector 9. A resin insulating member 16 having a through-hole is interposed between the tab 9a of the collector 9 and the reversion plate 15, and the tab 9a of the collector 9 is connected to the reversion plate 15 through the through-hole in the insulating member 16. With the structure above, the positive electrode substrate exposed portion 8 is electrically connected to the external positive electrode terminal 6 via the collector 9, the tab 9a of the collector 9, the reversion plate 15, and the conductive member 14.

Here, the current interruption mechanism comprises the reversion plate 15, the tab 9a of the collector 9, and the insulating member 16. In other words, the reversion plate 15 is deformed toward the through-hole 6b in the external positive electrode terminal 6 when the pressure in the outer can 1 increases, and the central part of the reversion plate 15 is welded to the thin-wall portion 9b in the tab 9a of the collector 9. Thus, the pressure in the outer can 1 exceeding a predetermined value leads to the fracturing of the thin-wall portion 9b in the tab 9a of the collector 9 at the annular groove 9c, thereby interrupting the electrical connection between the reversion plate 15 and the collector 9. In addition to the current interruption mechanism above, a current interruption mechanism may be adopted that has a structure in which a metal foil is welded to the reversion plate 15, the periphery of the welded portion is welded to the collector, and the metal foil fractures when the pressure in the outer can 1 increases to deform the reversion plate 15. A current interruption mechanism may be adopted that has another structure in which the connection strength between the tab 9a of the collector 9 and the reversion plate 15 is designed so that the connection portion between the tab 9a of the collector 9 and the reversion plate 15 fractures when the pressure in the outer can 1 exceeds a predetermined value.

The through-hole 6b formed in the external positive electrode terminal 6 is sealed with a rubber terminal stopper 17. On the terminal stopper 17, a metal plate member 18 is welded and fixed to the external positive electrode terminal 6 by laser-welding.

In the embodiment described here, the positive electrode conductive pathway is provided with the current interruption mechanism. However, the negative electrode conductive pathway may be provided with the current interruption mechanism.

To complete the prismatic lithium ion secondary battery 10, the electrode assembly 2 is electrically connected to the external positive electrode terminal 6 and the external negative electrode terminal 7, and is inserted into the outer can 1. The sealing plate 3 is then fitted onto the mouth of the outer can 1, and the fitting portion is laser-welded to seal the mouth. Next, a predetermined amount of an electrolyte is poured through the electrolyte pour hole (not shown in the drawings), and the electrolyte pour hole is then sealed with the sealing member 5.

In the prismatic lithium ion secondary battery 10, a space on the current interruption mechanism corresponding to the outer side of the battery is completely sealed up. When the pressure in the outer can 1 further increases after the current interruption mechanism works, the gas exhaust valve 4 provided in the sealing plate 3 opens to exhaust gas to the outside of the battery.

The method for manufacturing the prismatic lithium ion secondary battery 10 will next be described in further detail.

Preparation of Positive Electrode Sheet

Li₂CO₃ and (Ni_{0.35}Co_{0.35}Mn_{0.3})₃O₄ were mixed so that the molar ratio of Li and (Ni_{0.35}Co_{0.35}Mn_{0.3}) would be 1:1. Subsequently, the mixture was burnt at 900° C. for 20 hours in an air atmosphere to obtain a lithium transition-metal oxide represented by LiNi_{0.35}Co_{0.35}Mn_{0.3}O₂ as a positive electrode active material. An N-methylpyrrolidone (NMP) solution of the positive electrode active material obtained as above, flaked graphite and carbon black as conductive materials, and polyvinylidene fluoride (PVdF) as a binder was kneaded so that the mass ratio of positive electrode active material:flaked graphite:carbon black:PVdF would be 88:7:2:3 to prepare a positive electrode slurry. The prepared positive electrode slurry was applied onto both sides of an aluminum alloy foil (thickness of 15 μm) as a positive electrode substrate, and was dried to remove NMP used as a solvent for the preparation of the slurry, and whereby a positive electrode active material mixture layer was obtained. Next, the resultant object was rolled with a mill roll so that the positive electrode active material layer obtained a predetermined packing density (2.61 g/cm³). The positive electrode sheet was cut into a predetermined size so that a positive electrode substrate exposed portion, on which the positive electrode active material layer was not formed, would be formed on one end along a longitudinal direction and on both sides of the positive electrode sheet, and whereby a positive electrode sheet was obtained. The positive electrode active material layer preferably has a packing density of from 2.0 to 2.9 g/cm³, more preferably from 2.2 to 2.8 g/cm³, and even more preferably from 2.4 to 2.8 g/cm³.

Preparation of Negative Electrode Sheet

Natural graphite as a negative electrode active material, carboxymethylcellulose (CMC) as a thickener, and styrene-butadiene-rubber (SBR) as a binder were kneaded together with water to obtain a negative electrode slurry. Here, the materials were mixed so that the mass ratio of negative electrode active material:CMC:SBR would be 98:1:1. Next, the prepared negative electrode slurry was applied onto both sides of a copper foil (thickness of 10 μm) as a negative electrode substrate, and was dried to remove water used as a solvent for the preparation of the slurry, and whereby a negative electrode active material mixture layer was obtained. Subsequently, the resultant object was rolled using a mill roller so that the negative electrode active material layer obtained a predetermined packing density (1.11 g/cm³). The negative electrode active material layer preferably has a packing density of from 0.9 to 1.5 g/cm³.

Next, a protective layer was formed on a surface of the negative electrode active material layer. Alumina powder, a binder (acrylic resin), and NMP as a solvent were mixed so that a weight ratio was 30:0.9:69.1. The mixture was subjected to mixing and dispersion treatment with a bead mill to obtain a protective layer slurry. The protective layer slurry prepared as above was applied onto the negative electrode mixture layer prepared on the negative electrode sheet as above, and was dried to remove NMP used as a solvent. Thereby, a protective layer including alumina and the binder was formed on the negative electrode surface. The protective layer including alumina and the binder had a thickness of 3 μm. Subsequently, the negative electrode sheet was cut into a predetermined size so that a negative electrode substrate exposed portion, on which the negative electrode active material layer was not formed, would be formed on one end along a longitudinal direction and on both sides of the negative electrode sheet, and whereby a negative electrode sheet was obtained.

Each packing density of the positive electrode sheet and the negative electrode sheet was determined as follows. First, an electrode sheet was cut into an area of 10 cm², and the mass A (g) of the electrode sheet of 10 cm² and the thickness C (cm) of the electrode sheet were measured. Next, the mass B (g) of a substrate of 10 cm² and the thickness D (cm) of the substrate were measured. Subsequently, the packing density was calculated in accordance with the equation.

Packing density=(A−B)/[(C−D)×10 cm²]

Preparation of Flat Electrode Assembly

Using the positive electrode sheet and the negative electrode sheet prepared as above, the positive electrode sheet and the negative electrode sheet were wound with a microporous polyethylene separator interposed therebetween so that the positive electrode substrate exposed portion would be disposed on one end in the winding axis direction and the negative electrode substrate exposed portion would be disposed on the other end, and whereby a cylindrical-shaped electrode assembly was obtained. Subsequently, the cylindrical-shaped electrode assembly was pressed to obtain a flat electrode assembly.

Preparation of Nonaqueous Electrolyte

A mixed solvent was used as a nonaqueous solvent for a nonaqueous electrolyte, the mixed solvent constituted of 30% by volume of ethylene carbonate (EC), 30% by volume of ethyl methyl carbonate (EMC), and 40% by volume of dimethyl carbonate (DMC). LiPF6 was added as an electrolyte salt to the mixed solvent so that the concentration would be 1 mol/L, and then cyclohexylbenzene was further added in an amount of 3.0 to 3.75% by mass to the mixed solvent, thereby obtaining an electrolyte.

Preparation of Conductive Pathway

The preparation procedure of a positive electrode conductive pathway comprising a current interruption mechanism will be described. First, a gasket 12 was disposed on the top face of an aluminum sealing plate 3, and an insulating member 13 and an aluminum conductive member 14 were disposed on the bottom face of the sealing plate 3. A cylinder portion 6a of an aluminum external positive electrode terminal 6 was inserted through a through-hole provided in each of the members. Next, a leading end portion 6c of the external positive electrode terminal 6 was crimped to integrally fix the external positive electrode terminal 6, the gasket 12, the sealing plate 3, the insulating member 13, and the conductive member 14. Subsequently, the connection portion between the leading end portion 6c of the external positive electrode terminal 6 and the conductive member 14 was welded by laser-welding.

Next, a peripheral part of the lower end of a cylinder-shaped portion of the cup-shaped conductive member 14 was welded to the periphery of the reversion plate 15 for complete sealing. The reversion plate 15 used here was a thin aluminum plate that was molded so as to have the bottom portion protruding. The welding method between the conductive member 14 and the reversion plate 15 was laser-welding.

A resin insulating member 16 was brought into contact with the reversion plate 15, and the insulating member 16 and the insulating member 13 were fixed with latches. Next, a protrusion portion (not shown in the drawings) provided on the bottom face of the insulating member 16 was inserted into a through-hole 9d provided in a tab 9a of an aluminum collector 9. The protrusion portion was then heated for expanding the diameter thereof to fix the insulating member 16 to the collector 9. Subsequently, a region surrounded by a groove 9c of the collector 9 was welded to the reversion plate 15 by laser-welding. Next, N₂ gas at a predetermined pressure was introduced from the top of the external positive electrode terminal 6 into the through-hole 6b to examine the sealing condition of the welded portion between the conductive member 14 and the reversion plate 15.

Subsequently, a terminal stopper 17 was inserted into the through-hole 6b of the external positive electrode terminal 6. An aluminum plate member 18 was welded and fixed to the external positive electrode terminal 6 by laser-welding.

For the negative electrode conductive pathway, a gasket was disposed on the top face of the sealing plate 3, and an insulating member and a negative electrode collector were disposed on the bottom face of the sealing plate 3. A cylinder portion of the external negative electrode terminal 7 was inserted into a through-hole formed in each of the members. Next, a leading end portion of the external negative electrode terminal 7 was crimped to integrally fix the external negative electrode terminal 7, the gasket, the sealing plate 3, the insulating member, and the negative electrode collector. Subsequently, the connection portion between the leading end portion of the external negative electrode terminal 7 and the negative electrode collector was welded by laser-welding.

Production of Prismatic Lithium Ion Secondary Battery

The positive electrode collector 9 fixed to the sealing plate 3 as above and a positive electrode collector receiving part 11 were brought into contact with and resistance-welded to both outer faces of the positive electrode substrate exposed portion 8 of the electrode assembly 2, and as a result, the positive electrode collector 9, the plurality of stacked positive electrode substrate exposed portions 8, and the positive electrode collector receiving part 11 were integrally welded and connected to each other. Separately, the negative electrode collector fixed to the sealing plate 3 as above and a negative electrode collector receiving part were brought into contact with and resistance-welded to both outer faces of the negative electrode substrate exposed portion of the electrode assembly 2, and as a result, the negative electrode collector, the plurality of stacked negative electrode substrate exposed portions, and the electrode collector receiving part were integrally welded and connected to each other. When the number of stacked substrate exposed portions is large, it is preferable that the stacked substrate exposed portions be divided into two portions, a metal intermediate member be interposed between the portions, and the collector, the stacked substrate exposed portion, the intermediate member, the stacked substrate exposed portion, and the collector receiving part be integrally resistance-welded. In such a case, it is more preferable that the collector and the collector receiving part be integrally formed by bending a piece of metal member.

Next, a periphery of the electrode assembly 2 was covered with an insulating sheet (not shown in the drawings), and then the electrode assembly 2 with the insulating sheet was inserted into an aluminum prismatic outer can 1. The sealing plate 3 was fitted to the mouth of the outer can 1. Subsequently, the fitting portion between the sealing plate 3 and the outer can 1 was laser-welded.

### EXAMPLE 1

The nonaqueous electrolyte prepared as above was poured through a pour hole provided in the sealing plate 3 so that the amount of cyclohexylbenzene present in the outer body would be 3.4% with respect to the spatial volume in the outer body in terms of volume ratio. The pour hole was then sealed with a blind rivet, and consequently a nonaqueous electrolyte secondary battery of Example 1 was prepared. Here, the spatial volume in the outer body was 63 cc, and the working pressure of the current interruption mechanism was designed at 0.7 MPa.

### EXAMPLE 2

A nonaqueous electrolyte secondary battery of Example 2 was prepared in the same manner as in Example 1 except that the nonaqueous electrolyte prepared as above was poured so that the amount of cyclohexylbenzene present in the outer body would be 3.6% with respect to the spatial volume in the outer body in terms of volume ratio.

### COMPARATIVE EXAMPLE 1

A nonaqueous electrolyte secondary battery of Comparative Example 1 was produced in the same manner as in Example 1 except that the nonaqueous electrolyte prepared as above was poured so that the amount of cyclohexylbenzene present in the outer body would be 2.9% with respect to the spatial volume in the outer body in terms of volume ratio.

### EXAMPLE 3

A nonaqueous electrolyte secondary battery of Example 3 was produced in the same manner as in Example 1 except that the spatial volume in the outer body was 176 cc, the nonaqueous electrolyte prepared as above was poured so that the amount of cyclohexylbenzene present in the outer body would be 3.6% with respect to the spatial volume in the outer body in terms of volume ratio, and the working pressure of the current interruption mechanism was designed at 0.61 MPa.

### EXAMPLE 4

A nonaqueous electrolyte secondary battery of Example 4 was produced in the same manner as in Example 3 except that the nonaqueous electrolyte prepared as above was poured so that the amount of cyclohexylbenzene in the electrolyte present in the outer body would be 3.8% with respect to the spatial volume in the outer body in terms of volume ratio.

### COMPARATIVE EXAMPLE 2

A nonaqueous electrolyte secondary battery of Comparative Example 2 was produced in the same manner as in Example 3 except that the nonaqueous electrolyte prepared as above was poured so that the amount of cyclohexylbenzene in the electrolyte present in the outer body would be 4.8% with respect to the spatial volume in the outer body in terms of volume ratio.

In Examples 1 to 4, Comparative Example 1, and Comparative Example 2, the amount of cyclohexylbenzene as the overcharge inhibitor with respect to the spatial volume in the outer body was calculated by the method below.

[Calculation Method for Spatial Volume in Outer Body]

The spatial volume in the outer body is calculated by subtracting the real volume of constituent components stored in the enclosed space, such as an electrode assembly, from the volume of the space enclosed by the outer body and the sealing plate. Examples of the constituent materials excluding the electrode assembly include a collector, an insulating member, an insulating sheet, and members constituting the current interruption mechanism. The real volume of the electrode assembly and other components does not include the void volumes of positive and negative electrodes, a separator, and other components. The real volume also does not include the volume of a nonaqueous electrolyte present in the outer body.

[Calculation Method for Volume Ratio of Overcharge Inhibitor with Respect to Spatial Volume in Outer Body]

The volume of cyclohexylbenzene contained in the nonaqueous electrolyte poured was divided by the spatial volume in the outer body determined through the method above, and the result was expressed in percentage. Each volume was determined in a condition of 25° C. and 1 atmosphere (101,325 Pa).

The following measurements were performed on each nonaqueous electrolyte secondary battery of Example 1, Example 2, and Comparative Example 1. Each nonaqueous electrolyte secondary battery of Example 1, Example 2, and Comparative Example 1 had a battery capacity of 5 Ah.

Measurement of Ambient Temperature Output Characteristics

An ambient temperature output power was determined as follows: a battery was charged at a room temperature of 25° C. at a charging current of 5 A until the state of charge reached 50%; a 10-second discharge was performed at currents of 25 A, 50 A, 90 A, 120 A, 150 A, 180 A, and 210 A; each battery voltage was measured; each electric current value was plotted with respect to the corresponding battery voltage; and the ambient temperature output power was calculated from the I-V characteristics at the time of discharging. The state of charge deviation caused by discharging was corrected by charging at a constant current of 5 A to the original state of charge.

Measurement of Low Temperature Output Characteristics

A low temperature output power was determined as follows: a battery was charged at a low temperature of −30° C. at a charging current of 5 A until the state of charge reached 50%; a 10-second discharge was performed at currents of 8 A, 16 A, 24 A, 32 A, 40 A, and 48 A; each battery voltage was measured; each electric current value was plotted with respect to the corresponding battery voltage; and the low temperature output power was calculated from the I-V characteristics at the time of discharging. The state of charge deviation caused by discharging was corrected by charging at a constant current of 5 A to the original state of charge.

Condition for Low Temperature Overcharge Test

A low temperature overcharge test was carried out as follows: a battery was charged under an environment at 5° C. at 20 A until the state of charge reached 170%; the battery was then charged at 125 A until the voltage reached 30 V; and the battery was further charged at a constant voltage of 30 V.

The following measurements were performed on each nonaqueous electrolyte secondary battery of Example 3, Example 4, and Comparative Example 2. Each nonaqueous electrolyte secondary battery of Example 3, Example 4, and Comparative Example 2 had a battery capacity of 21.5 Ah.

[Measurement of Ambient Temperature Output Characteristics]

An ambient temperature output power was determined as follows: a battery was charged at a room temperature of 25° C. at a charging current of 21.5 A until the state of charge reached 50%; a 10-second discharge was performed at currents of 40 A, 80 A, 120 A, 160 A, 200 A, and 240 A; each battery voltage was measured; each electric current value was plotted with respect to the corresponding battery voltage; and the ambient temperature output power was calculated from the I-V characteristics at the time of discharging. The state of charge deviation caused by discharging was corrected by charging at a constant current of 21.5 A to the original state of charge.

[Measurement of Low Temperature Output Characteristics]

A low temperature output power was determined as follows: a battery was charged at a low temperature of −30° C. at a charging current of 21.5 A until the state of charge reached 50%; a 10-second discharge was performed at currents of 20 A, 40 A, 60 A, 80 A, 100 A, and 120 A; each battery voltage was measured; each electric current value was plotted with respect to the corresponding battery voltage; and the low temperature output power was calculated from the I-V characteristics at the time of discharging. The state of charge deviation caused by discharging was corrected by charging at a constant current of 21.5 A to the original state of charge.

[Condition for Low Temperature Overcharge Test]

A low temperature overcharge test was carried out as follows: a battery was charged under an environment at 5° C. at 20 A until the state of charge reached 145%; the battery was then charged at 125 A until the voltage reached 30 V; and the battery was further charged at a constant voltage of 30 V.

Test Results

Table 1 and Table 2 show the test results of Examples 1 to 4, Comparative Example 1, and Comparative Example 2 together with the spatial volume in an outer body, the amount of cyclohexylbenzene contained in a nonaqueous electrolyte, the amount of cyclohexylbenzene with respect to the spatial volume in an outer body, and the working pressure of a current interruption mechanism. In Table 1, the ambient temperature output power and the low temperature output power are values when the values of the nonaqueous electrolyte secondary battery of Example 1 are regarded as 100%. In Table 2, the ambient temperature output power and the low temperature output power are values when the values of the nonaqueous electrolyte secondary battery of Example 3 are regarded as 100%.

TABLE 1

| | | | | Working | | | |
|---|---|---|---|---|---|---|---|
| | | Amount of | Amount of | pressure of | | | |
| | Spatial | cyclohexylbenzene | cyclohexylbenzene | current | Ambient | Low | Low |
| | volume in | contained in | contained in nonaqueous | interruption | temperature | temperature | temperature |
| | outer | nonaqueous electrolyte | electrolyte/spatial volume | mechanism | output power | output power | overcharge |
| | body (cc) | (cc) | in outer body (%) | (MPa) | (%) | (%) | test |
| Example 1 | 63 | 2.14 | 3.4 | 0.7 | 100.0 | 100.0 | No particular |
| | | | | | | | event |
| Example 2 | 63 | 2.29 | 3.6 | 0.7 | 99.2 | 99.5 | No particular |
| | | | | | | | event |
| Comparative | 63 | 1.83 | 2.9 | 0.7 | 102.5 | 100.5 | Internal |
| Example 1 | | | | | | | burning |

TABLE 2

| | | | | Working | | | |
|---|---|---|---|---|---|---|---|
| | | Amount of | Amount of | pressure of | | | |
| | Spatial | cyclohexylbenzene | cyclohexylbenzene | current | Ambient | Low | Low |
| | volume in | contained in | contained in nonaqueous | interruption | temperature | temperature | temperature |
| | outer | nonaqueous electrolyte | electrolyte/spatial volume | mechanism | output power | output power | overcharge |
| | body (cc) | (cc) | in outer body (%) | (MPa) | (%) | (%) | test |
| Example 3 | 176 | 6.28 | 3.6 | 0.61 | 100.0 | 100.0 | No particular |
| | | | | | | | event |
| Example 4 | 176 | 6.69 | 3.8 | 0.61 | 99.0 | 97.8 | No particular |
| | | | | | | | event |
| Comparative | 176 | 8.37 | 4.8 | 0.61 | 96.7 | 83.9 | No particular |
| Example 2 | | | | | | | event |

As can be seen from Table 1 and Table 2, in Comparative Example 1, in which the nonaqueous electrolyte contained cyclohexylbenzene as the overcharge inhibitor in an amount of less than 3.0% with respect to the spatial volume in the outer body in terms of volume ratio, the battery inner pressure at the time of overcharging did not sufficiently increase, failing to activate the current interruption mechanism in a short period of time, and consequently an abnormal event, namely, internal burning in this example, was caused. Meanwhile, in Comparative Example 2, in which the nonaqueous electrolyte contained cyclohexylbenzene as the overcharge inhibitor in an amount of more than 4.5% with respect to the spatial volume in the outer body in terms of volume ratio, the battery inner pressure at the time of overcharging could increase for a short period of time thereby immediately activating the current interruption mechanism, and consequently safety could be ensured. However, the output characteristics, especially the output characteristics at low temperature, were greatly lowered. In contrast, in Examples 1 to 4, each battery had sufficient output characteristics, even in a low temperature condition, to ensure reliability even when the battery was overcharged through the two-step charging in a low temperature condition. This revealed that the nonaqueous electrolyte preferably contains the overcharge inhibitor in an amount of 3% or more and 4.5% or less with respect to the spatial volume in the outer body in terms of volume ratio. During the second charging, as shown in Comparative Example 1, the activation of the current interruption mechanism was likely to be delayed in spite of the fact that the battery was so overcharged that the current interruption mechanism would work. This is thought to have occurred because the decomposition of a positive electrode is likely to start prior to the increase of the battery internal pressure, and also because further increase of the voltage readily leads to the start of the decomposition of the electrolyte in the second charging.

In the invention, the amount of an overcharge inhibitor is preferably adjusted so as to increase the internal pressure of a battery case to the working pressure of a current interruption mechanism (for example, from 0.4 to 1.0 MPa, typically from 0.65 MPa to 0.75 MPa) within 1,200 seconds (preferably within 1,000 seconds, typically within 750 seconds) from the start of the first step charging when the battery is charged at the first step in a condition at a predetermined temperature (for example, from −30° C. to 60° C., typically 5° C.) at a predetermined current rate (for example, from 5 A to 125 A, typically 20 A; for example, from 1 C to 25 C, typically 4 C in terms of C rate) until the voltage reaches 4.7 V and then is charged at the second step at a predetermined current rate (for example, from 100 A to 125 A, typically 125 A; for example, from 20 C to 25 C, typically 25 C).

As described above, the invention can provide a nonaqueous electrolyte secondary battery that has excellent output characteristics in a low temperature condition, can sufficiently ensure reliability even when the battery is overcharged through two-step charging in a low temperature condition, and is suited for a nonaqueous electrolyte secondary battery for vehicles requiring excellent output characteristics and high reliability. However, the nonaqueous electrolyte secondary battery of the invention is not limited to a nonaqueous electrolyte secondary battery for vehicles and can be suitably applied to a nonaqueous electrolyte secondary battery for large storage battery systems requiring excellent output characteristics.

<Others>

The working pressure of the current interruption mechanism is not necessarily limited because it is controlled as appropriate depending on the kinds of active material, a battery capacity, a battery energy density, and the application of a battery, but is preferably adjusted at about from 0.4 to 1.5 MPa. The current interruption mechanism cannot be reset or can be reset, but it is preferable that the current interruption mechanism cannot be reset.

In the nonaqueous electrolyte secondary battery of the invention, as a nonaqueous solvent (organic solvent) contained in the nonaqueous electrolyte, carbonates, lactones, ethers, esters, and other solvents that are commonly used in a nonaqueous electrolyte secondary battery can be used, and two or more of these solvents may be mixed to be used. Among them, carbonates, lactones, ethers, ketones, esters, and other solvents are preferred, and carbonates are more suitably used.

Usable example of the carbonate include cyclic carbonates such as ethylene carbonate, propylene carbonate, and butylene carbonate, and chain carbonates such as dimethyl carbonate, ethyl methyl carbonate, and diethyl carbonate. In particular, a mixed solvent of a cyclic carbonate and a chain carbonate is preferably used. An unsaturated cyclic carbonate such as vinylene carbonate (VC) may also be added to the nonaqueous electrolyte. The nonaqueous solvent more preferably contains ethylene carbonate and at least one of ethyl methyl carbonate and dimethyl carbonate.

In the invention, as a solute in the nonaqueous electrolyte, lithium salts that are commonly used in a nonaqueous electrolyte secondary battery may be used. Examples of such a lithium salt include LiPF₆, LiBF₄, LiCF₃SO₃, LiN(CF₃SO₂)₂, LiN(C₂F₅SO₂)₂, LiN(CF₃SO₂)(C₄F₉SO₂)₃, LiC(C₂F₅SO₂)₃, LiC(C₂F₅SO₂)₃, LiAsF₆, LiClO₄, Li₂B₁₀Cl₁₀, Li₂B₁₂Cl₁₂, LiB(C₂O₄)₂, LiB(C₂O₄)F₂, LiP(C₂O₄)₃, LiP(C₂O₄)₂F₂, LiP(C₂O₄)F₄, and mixtures of these substances. Among them, LiPF₆ (lithium hexafluorophosphate) is preferably used. The nonaqueous solvent preferably dissolves a solute in an amount of 0.5 to 2.0 mol/L.

In the nonaqueous electrolyte secondary battery of the invention, as the overcharge inhibitor, a compound that starts to decompose at the time of overcharging to generate gas can be used, such as cumene, 1,3-diisopropylbenzene, 1,4-diisopropylbenzene, 1-methylpropylbenzene, 1,3-bis(1-methylpropyl)benzene, 1,4-bis(1-methylpropyl)benzene, t-butylbenzene, t-dibutylbenzene, t-amylbenzene, t-diamylbenzene, cyclohexylbenzene, cyclopentylbenzene, biphenyl, and diphenyl ether. In particular, cyclohexylbenzene is preferably used.

In the nonaqueous electrolyte secondary battery of the invention, a porous separator of a polyolefin such as polypropylene (PP) and polyethylene (PE) is preferably used as the separator. A separator having a three-layered structure of polypropylene (PP) and polyethylene (PE) (PP/PE/PP or PE/PP/PE) may also be used.

The invention is particularly effective when it is applied to a nonaqueous electrolyte secondary battery having a large capacity of 5 Ah or more, especially a nonaqueous electrolyte secondary battery having a large capacity of 20 Ah or more. The nonaqueous electrolyte secondary battery can be charged and discharged at high electric current and is excellent in reliability at the time of overcharging. The nonaqueous electrolyte secondary battery is therefore most suitable as a battery for vehicles such as EVs, PHEVs, and HEVs.

What is claimed is:

1. A nonaqueous electrolyte secondary battery comprising:
an electrode assembly including a positive electrode sheet; a negative electrode sheet; and a separator interposed between the positive electrode sheet and the negative electrode sheet;
an outer body storing the electrode assembly and a nonaqueous electrolyte;
a first conductive pathway from the positive electrode sheet to the outside of the outer body;
a second conductive pathway from the negative electrode sheet to the outside of the outer body; and
a current interruption mechanism that is provided in at least one of the first conductive pathway and the second conductive pathway and interrupts electric current when the pressure in the outer body exceeds a predetermined value,
the nonaqueous electrolyte containing an overcharge inhibitor, and the overcharge inhibitor being contained in an amount of 3.0% or more and 4.5% or less with respect to the spatial volume in the outer body in terms of volume ratio.

2. The nonaqueous electrolyte secondary battery according to claim 1, wherein the overcharge inhibitor is a compound having at least one of a cyclohexyl group and a phenyl group.

3. The nonaqueous electrolyte secondary battery according to claim 2, wherein the compound having at least one of a cyclohexyl group and a phenyl group is at least one compound selected from cumene, 1,3-diisopropylbenzene, 1,4-diisopropylbenzene, 1 -methylpropylbenzene, 1,3 -bis(1-methylpropyl)benzene, 1,4-bis(1-methylpropyl)benzene, t-butylbenzene, t-dibutylbenzene, t-amylbenzene, t-diamylbenzene, cyclohexylbenzene, cyclopentylbenzene, biphenyl, and diphenyl ether.

4. The nonaqueous electrolyte secondary battery according to claim 1, wherein a nonaqueous solvent included in the nonaqueous electrolyte contains at least one solvent selected from the group consisting of ethylene carbonate, ethyl methyl carbonate, and dimethyl carbonate.

5. The nonaqueous electrolyte secondary battery according to claim 1, further comprising:
a gas exhaust valve for exhausting gas in the outer body to the outside of the outer body when the pressure in the outer body exceeds a predetermined value, wherein
the current interruption mechanism works at a pressure lower than that for the gas exhaust valve, and the current interruption mechanism works at a pressure of 0.4 MPa or more and 1.0 MPa or less.

6. The nonaqueous electrolyte secondary battery according to claim 1, wherein the positive electrode sheet contains, as the positive electrode active material, a lithium transition-metal composite oxide capable of absorbing and desorbing lithium ions, and the negative electrode sheet contains, as the negative electrode active material, a carbon material capable of absorbing and desorbing lithium ions.

7. The nonaqueous electrolyte secondary battery according to claim 1, wherein at least one of the positive electrode sheet and the negative electrode sheet has a surface provided with a protective layer including an inorganic oxide and a binder, and the inorganic oxide is at least one selected from alumina, titania, and zirconia.

8. The nonaqueous electrolyte secondary battery according to claim 1, wherein the outer body is a prismatic outer body; the electrode assembly is a flat electrode assembly, the flat electrode assembly has one end with a plurality of stacked positive electrode substrate exposed portions and have the other end with a plurality of stacked negative electrode substrate exposed portions, the positive electrode substrate exposed portions are disposed to face one sidewall of the prismatic outer body, the negative electrode substrate exposed portions are disposed to face the other sidewall of the prismatic outer body, the positive electrode substrate exposed portions are connected to a positive electrode collector, and the negative electrode substrate exposed portions are connected to a negative electrode collector.

9. A method for manufacturing a nonaqueous electrolyte secondary battery comprising:
preparing an electrode assembly including a positive electrode sheet, a negative electrode sheet, and a separator interposed between the positive electrode sheet and the negative electrode sheet;
storing the electrode assembly and a nonaqueous electrolyte containing an overcharge inhibitor in an outer body and adjusting the nonaqueous electrolyte to contain the overcharge inhibitor in an amount of 3.0% or more and 4.5% or less with respect to the spatial volume in the outer body in terms of volume ratio; and
sealing up the outer body.

10. A vehicle comprising a nonaqueous electrolyte secondary battery,
the nonaqueous electrolyte secondary battery including:
an electrode assembly including a positive electrode sheet, a negative electrode sheet, and a separator interposed between the positive electrode sheet and the negative electrode sheet,
an outer body storing the electrode assembly and a nonaqueous electrolyte, and
a current interruption mechanism that is provided in at least one of a conductive pathway from the positive electrode sheet to the outside of the outer body and a conductive pathway from the negative electrode sheet to the outside of the outer body and interrupts electric current when the pressure in the outer body exceeds a predetermined value,
the nonaqueous electrolyte containing an overcharge inhibitor, and the overcharge inhibitor being contained in an amount of 3.0% or more and 4.5% or less with respect to the spatial volume in the outer body in terms of volume ratio.
